(19) United States
(12) Patent Application Publication
(10) Pub. No.: US 2026/0084823 A1
(43) Pub. Date: Mar. 26, 2026

(54) ENVIRONMENTAL CONTROL SYSTEM WITH CABIN VENT-AIR COOLED HEAT EXCHANGER AND WATER VAPOR COGENERATION

(71) Applicant: Hamilton Sundstrand Corporation, Charlotte, NC (US)

(72) Inventors: Viktor Kilchyk, Lancaster, NY (US); Lance R. Bartos, Granby, MA (US)

(21) Appl. No.: 18/891,455

(22) Filed: Sep. 20, 2024

(51) Int. Cl. B64D 13/08; B64D 13/06

(52) U.S. Cl. CPC B64D 13/08; B64D 2013/0644; B64D 2013/0648; B64D 2013/0688

(57) ABSTRACT

An environmental control system of an aircraft, having a first flow circuit that transports a first flow to a cabin; a second flow circuit that transports a second flow away from the cabin and is fluidly separated from the first flow circuit; wherein the first flow circuit includes: a first compressor that is a cabin air compressor; an air cycle machine (ACM) downstream of the first compressor; and a primary heat exchanger between the first compressor and the ACM, and wherein the second flow circuit directs the second flow to the primary heat exchanger to condition the first flow prior to reaching the ACM.

### BACKGROUND

The embodiments are directed to an environmental control system (ECS) for an aircraft and more specifically to an ECS with a cabin vent-air cooled heat exchanger and water vapor cogeneration.

An ECS is responsible for a significant part of the aircraft fuel consumption. An ECS may be unable to recover energy when an aircraft is on the ground, where thermal loading of the ECS may be the greatest. The result is a waste of usable energy.

### BRIEF SUMMARY

Disclosed is an environmental control system of an aircraft, including a first flow circuit that transports a first flow to a cabin; a second flow circuit that transports a second flow away from the cabin and is fluidly separated from the first flow circuit; wherein the first flow circuit includes: a first compressor that is a cabin air compressor; an air cycle machine (ACM) downstream of the first compressor; and a primary heat exchanger between the first compressor and the ACM, and wherein the second flow circuit directs the second flow to the primary heat exchanger to condition the first flow prior to reaching the ACM.

In addition to one or more aspects of the system or as an alternate, the second flow circuit includes a cabin exhaust vent that directs cabin air to the second flow circuit.

In addition to one or more aspects of the system or as an alternate, the first flow circuit further includes: a first turbine coupled to the first compressor; and an auxiliary heat exchanger between the first compressor and the primary heat exchanger, and the second flow circuit extends from the primary heat exchanger to the first turbine via the auxiliary heat exchanger, to thereby extract energy from the first flow and drive the first turbine.

In addition to one or more aspects of the system or as an alternate: the ACM includes an ACM compressor and an ACM turbine; and the first flow circuit includes a secondary heat exchanger between the ACM compressor and the ACM turbine for conditioning the first flow prior to reaching the ACM turbine.

In addition to one or more aspects of the system or as an alternate, the first flow circuit includes: a first water separator between the secondary heat exchanger and the ACM turbine to extract water from the first flow circuit.

In addition to one or more aspects of the system or as an alternate, the first water separator is coupled to the second flow circuit, at a first junction between the primary heat exchanger and the auxiliary heat exchanger, whereby the second flow enters the auxiliary heat exchanger as a water spray that transitions to steam within the auxiliary heat exchanger.

In addition to one or more aspects of the system or as an alternate, the second flow circuit includes: an ejector at the first junction in the second flow circuit, whereby pressurized air and the water from the first water separator is combined with the second flow from the primary heat exchanger upstream of the auxiliary heat exchanger.

In addition to one or more aspects of the system or as an alternate, the first flow circuit includes: a second water separator, downstream of the ACM turbine, to remove water from the first flow, and the second flow circuit is coupled to the second water separator, at a second junction between the primary heat exchanger and the ejector.

In addition to one or more aspects of the system or as an alternate, the second flow circuit includes: an upstream heat exchanger, that is upstream of the primary heat exchanger, to remove heat from one or more aircraft systems.

In addition to one or more aspects of the system or as an alternate, the system includes: a motor coupled to the first compressor and the first turbine.

In addition to one or more aspects of the system or as an alternate: the secondary heat exchanger is a ram air heat exchanger.

In addition to one or more aspects of the system or as an alternate, the first flow circuit includes a return branch connected to a third junction between the first compressor and the auxiliary heat exchanger, wherein the return branch directs at least a portion of the first flow to the first compressor.

In addition to one or more aspects of the system or as an alternate, the system includes an add heat valve located in the return branch.

Disclosed is another embodiment of the environmental control system of the aircraft, including a first flow circuit that transports a first flow to a cabin; a second flow circuit that transports a second flow away from the cabin and is fluidly separated from the first flow circuit; wherein the first flow circuit includes: a first compressor that is a cabin air compressor; an air cycle machine (ACM) downstream of the first compressor; and a primary heat exchanger between the first compressor and the ACM, and a first turbine coupled to the first compressor; and an auxiliary heat exchanger between the first compressor and the primary heat exchanger, and the second flow circuit extends from the primary heat exchanger to the first turbine via the auxiliary heat exchanger, to thereby extract energy from the first flow and drive the first turbine.

In addition to one or more aspects of the another embodiment of the system or as an alternate, the second flow circuit directs cabin exhaust to the primary heat exchanger to condition the first flow prior to reaching the ACM.

In addition to one or more aspects of the another embodiment of the system or as an alternate: the ACM includes an ACM compressor and an ACM turbine; and the first flow circuit includes a secondary heat exchanger between the ACM compressor and the ACM turbine for conditioning the first flow prior to reaching the ACM turbine.

In addition to one or more aspects of the another embodiment of the system or as an alternate, the first flow circuit includes: a first water separator between the secondary heat exchanger and the ACM turbine to extract water from the first flow circuit, and

In addition to one or more aspects of the another embodiment of the system or as an alternate, the first water separator is coupled to the second flow circuit, at a first junction between the primary heat exchanger and the auxiliary heat exchanger, whereby the second flow enters the auxiliary heat exchanger as a water spray that transitions to steam within the auxiliary heat exchanger.

In addition to one or more aspects of the another embodiment of the system or as an alternate, the second flow circuit includes: an ejector at the first junction in the second flow circuit, whereby pressurized air and the water from the first water separator is combined with the second flow from the primary heat exchanger upstream of the auxiliary heat exchanger.

In addition to one or more aspects of the another embodiment of the system or as an alternate, the first flow circuit includes: a second water separator, downstream of the ACM turbine, to remove water from the first flow, and the second flow circuit is coupled to the second water separator, between the primary heat exchanger and the ejector.

### BRIEF DESCRIPTION OF THE DRAWINGS

The following descriptions should not be considered limiting in any way. With reference to the accompanying drawings, like elements are numbered alike:

FIG. 1 shows an environmental control system (ECS) of an aircraft, according to an embodiment.

### DETAILED DESCRIPTION

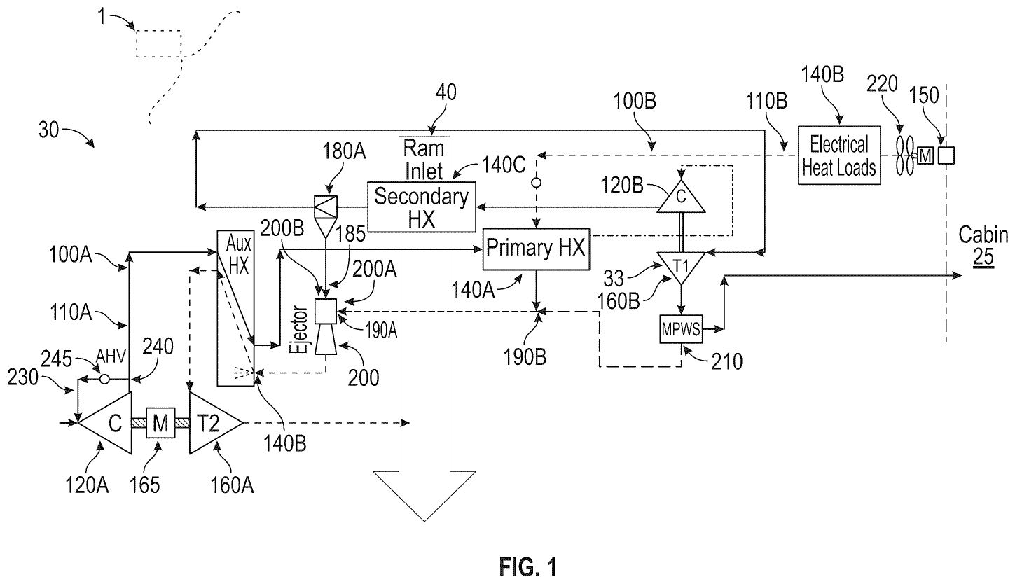

Turning to FIG. 1, an environmental control system (ECS) 30 of an aircraft 1 is shown. The ECS 30 includes a first flow circuit 100A that transports a first flow 110A to a cabin 25 of the aircraft 1. A second flow circuit 100B transports a second flow 110B, i.e., cabin exhaust, away from the cabin 25 and is fluidly separated from the first flow circuit 100A.

The first flow circuit 100A includes a first compressor 120A that is a cabin air compressor. An air cycle machine (ACM) 33 of the aircraft 1 is downstream of the first compressor 120A. A primary heat exchanger 140A is between the first compressor 120A and the ACM 33. The second flow circuit 100B directs the second flow 110B to the primary heat exchanger 140A to condition the first flow 110A prior to reaching the ACM 33. The second flow circuit 100B includes a cabin exhaust vent 150 that fluidly couples cabin exhaust to the second flow circuit 100B.

The first flow circuit 100A further includes a first compressor 120A coupled to the first turbine 160A. A motor 165 is coupled to the first compressor 120A and the first turbine 160A, which drives the first compressor 120A when, e.g., a flow rate in the second flow circuit 100B to the first turbine 160A is low. This may occur, e.g., when the aircraft 1 is on the ground. An auxiliary heat exchanger 140B is located between the first compressor 120A and the primary heat exchanger 140A. The second flow circuit 100B extends from the primary heat exchanger 140A to the first turbine 160A via the auxiliary heat exchanger 140B. This configuration enables extracting energy from the first flow 110A for driving the first turbine 160A under fluid pressure.

The ACM 33 includes an ACM compressor 120B and an ACM turbine 160B. The first flow circuit 100A includes a secondary heat exchanger 140C between the ACM compressor 120B and the ACM turbine 160B. The secondary heat exchanger 140C conditions the first flow 110A prior to reaching the ACM turbine 160B. The secondary heat exchanger 140C may use ram air from the ram air inlet 40 as the working fluid.

The first flow circuit 100A includes a first water separator 180A located between the secondary heat exchanger 140C and the ACM turbine 160B to extract water 185 from the first flow circuit 100A. The first water separator 180A is coupled to the second flow circuit 100B, at a first junction 190A between the primary heat exchanger 140A and the auxiliary heat exchanger 140B. With this configuration, the second flow 110B enters the auxiliary heat exchanger 140B as a water spray that transitions to steam within the auxiliary heat exchanger 140B.

An ejector 200 is located at the first junction 190A in the second flow circuit 100B, with the second flow 110B connected to the suction port 200A of the ejector 200 and the water flow 185 in the primary port 200B. From this configuration, pressurized air and water 185 from the first water separator 180A is combined with the second flow 110B from the primary heat exchanger upstream of the auxiliary heat exchanger 140B.

The first flow circuit 100A includes a second water separator 210, located downstream of the ACM turbine 160B. The second water separator 210 removes water from the first flow 110A prior to reaching the cabin 25. The second flow circuit 100B is coupled to the second water separator 210, at a second junction 190B between the primary heat exchanger 140A and the ejector 200.

In one embodiment, the second flow circuit 100B includes an upstream heat exchanger 140D, that is upstream of the primary heat exchanger 140A. The upstream heat exchanger 140D may be configured to remove heat from one or more aircraft heat loads. A fan 220 may be upstream of the upstream heat exchanger 140D for urging air from the cabin 25 into the second flow circuit 100B.

The first flow circuit 100A includes a return branch 230 connected to a third junction 240 between the first compressor 120A and the auxiliary heat exchanger 140B. The return branch 230 may direct a portion of the first flow 110A to the first compressor 120A. An add heat valve (AHV) 245 may be located in the return branch 230 to control the flow to the first compressor 120A.

With the above configuration, cabin vent-air cools the primary heat exchanger 140A rather than ram air. This reduces the reliance on ram air, increasing aerodynamic efficiency. The ejector 200 induces airflow through the primary heat exchanger 140A while on the ground. This is because the second flow circuit 100B is on the suction port 200A of the ejector 200, and the first flow circuit 100A, which feeds water to the primary port 200B of the ejector 200, is active from either the motor 165 or the first turbine 160A driving the first (CAC) compressor 120A. Water sprayed into the auxiliary heat exchanger 140B will generate steam to improve cooling of the first flow 110A by evaporation of the second flow 110B through the auxiliary heat exchanger 140B. Absorption of the energy by the second flow 110B will expand the second flow 110B as it travels to the first turbine 160A, increasing the operational efficiency of the first turbine 160A.

That is, the ejector 200 draws airflow across the primary heat exchanger 140A when there is near zero gage pressure at the cabin vent while on the ground. Further, using heat from the primary heat exchanger 140A and the auxiliary heat exchanger 140B, coupled with steam the generation in the second flow 110B, increases enthalpy of the cabin exhaust gas and boosts turbine power output from the first turbine 160A when turbine pressure ratio is low, i.e., when the aircraft is on the ground. As cabin air is typically cooler than ground ambient conditions, e.g., on hot days, cooling via the primary heat exchanger 140A is improved compared with utilizing relatively hot (ambient) ram air.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An environmental control system of an aircraft, comprising
a first flow circuit that transports a first flow to a cabin;
a second flow circuit that transports a second flow away from the cabin and is fluidly separated from the first flow circuit;
wherein the first flow circuit includes:
a first compressor that is a cabin air compressor;
an air cycle machine (ACM) downstream of the first compressor; and
a primary heat exchanger between the first compressor and the ACM, and
wherein the second flow circuit directs the second flow to the primary heat exchanger to condition the first flow prior to reaching the ACM.

2. The system of claim 1, wherein
the second flow circuit includes a cabin exhaust vent that directs cabin air to the second flow circuit.

3. The system of claim 1, wherein
the first flow circuit further includes:
a first turbine coupled to the first compressor; and
an auxiliary heat exchanger between the first compressor and the primary heat exchanger, and
the second flow circuit extends from the primary heat exchanger to the first turbine via the auxiliary heat exchanger, to thereby extract energy from the first flow and drive the first turbine.

4. The system of claim 3, wherein:
the ACM includes an ACM compressor and an ACM turbine; and
the first flow circuit includes a secondary heat exchanger between the ACM compressor and the ACM turbine for conditioning the first flow prior to reaching the ACM turbine.

5. The system of claim 4, wherein
the first flow circuit includes:
a first water separator between the secondary heat exchanger and the ACM turbine to extract water from the first flow circuit.

6. The system of claim 5, wherein
the first water separator is coupled to the second flow circuit, at a first junction between the primary heat exchanger and the auxiliary heat exchanger, whereby the second flow enters the auxiliary heat exchanger as a water spray that transitions to steam within the auxiliary heat exchanger.

7. The system of claim 6, wherein
the second flow circuit includes:
an ejector at the first junction in the second flow circuit, whereby pressurized air and the water from the first water separator is combined with the second flow from the primary heat exchanger upstream of the auxiliary heat exchanger.

8. The system of claim 7, wherein
the first flow circuit includes:
a second water separator, downstream of the ACM turbine, to remove water from the first flow, and
the second flow circuit is coupled to the second water separator, at a second junction between the primary heat exchanger and the ejector.

9. The system of claim 1, wherein
the second flow circuit includes:
an upstream heat exchanger, that is upstream of the primary heat exchanger, to remove heat from one or more aircraft systems.

10. The system of claim 3, including:
a motor coupled to the first compressor and the first turbine.

11. The system of claim 4, wherein:
the secondary heat exchanger is a ram air heat exchanger.

12. The system of claim 3, wherein
the first flow circuit includes a return branch connected to a third junction between the first compressor and the auxiliary heat exchanger, wherein the return branch directs at least a portion of the first flow to the first compressor.

13. The system of claim 12, including an add heat valve located in the return branch.

14. An environmental control system of an aircraft, comprising
a first flow circuit that transports a first flow to a cabin;
a second flow circuit that transports a second flow away from the cabin and is fluidly separated from the first flow circuit;
wherein the first flow circuit includes:
a first compressor that is a cabin air compressor;
an air cycle machine (ACM) downstream of the first compressor; and
a primary heat exchanger between the first compressor and the ACM, and
a first turbine coupled to the first compressor; and
an auxiliary heat exchanger between the first compressor and the primary heat exchanger, and
the second flow circuit extends from the primary heat exchanger to the first turbine via the auxiliary heat exchanger, to thereby extract energy from the first flow and drive the first turbine.

15. The system of claim 14, wherein
the second flow circuit directs cabin exhaust to the primary heat exchanger to condition the first flow prior to reaching the ACM.

16. The system of claim 15, wherein:
the ACM includes an ACM compressor and an ACM turbine; and
the first flow circuit includes a secondary heat exchanger between the ACM compressor and the ACM turbine for conditioning the first flow prior to reaching the ACM turbine.

17. The system of claim 16, wherein
the first flow circuit includes:
a first water separator between the secondary heat exchanger and the ACM turbine to extract water from the first flow circuit.

18. The system of claim 17, wherein
the first water separator is coupled to the second flow circuit, at a first junction between the primary heat exchanger and the auxiliary heat exchanger, whereby the second flow enters the auxiliary heat exchanger as a water spray that transitions to steam within the auxiliary heat exchanger.

19. The system of claim 18, wherein
the second flow circuit includes:
an ejector at the first junction in the second flow circuit, whereby pressurized air and the water from the first water separator is combined with the second flow from the primary heat exchanger upstream of the auxiliary heat exchanger.

20. The system of claim 19, wherein
the first flow circuit includes:
a second water separator, downstream of the ACM turbine, to remove water from the first flow, and
the second flow circuit is coupled to the second water separator, between the primary heat exchanger and the ejector.
